(19) United States
(12) Patent Application Publication
(10) Pub. No.: US 2021/0354395 A1
(43) Pub. Date: Nov. 18, 2021

(54) THERMAL SUPPORTS FOR FORMATION OF 3D OBJECT PORTIONS

(71) Applicant: HEWLETT-PACKARD DEVELOPMENT COMPANY, L.P., Spring, TX (US)

(72) Inventors: Arthur H. Barnes, Vancouver, WA (US); Vanessa Verzwyvelt, Vancouver, WA (US); Matthew A. Shepherd, Vancouver, WA (US)

(21) Appl. No.: 16/607,795

(22) PCT Filed: Jul. 31, 2018
(86) PCT No.: PCT/US18/44647

§ 371 Date: Oct. 24, 2019

(51) Int. Cl. B29C 64/393; B29C 64/165; B29C 64/40; B33Y 50/02

(52) U.S. Cl. CPC B29C 64/393; B29C 64/165; B33Y 10/00; B33Y 50/02; B29C 64/40

(57) ABSTRACT

According to examples, an apparatus may include a processor and a memory on which is stored machine readable instructions that may cause the processor to identify a color of a portion of a 3D object to be fabricated from a 3D model and to determine, based on the identified color of the portion, a property of a thermal support, in which the property may affect a temperature of an area near build material particles used to form the portion. The instructions may cause the processor to instruct fabrication components to fabricate the thermal support having the determined property and the fabrication components to fabricate the 3D object. The thermal support may be fabricated at a location with respect to the portion to increase a temperature of a set of particles used to fabricate the portion during fabrication of the portion.

### BACKGROUND

In three-dimensional (3D) printing, an additive printing process is often used to make three-dimensional solid parts from a digital model. Some 3D printing techniques are considered additive processes because they involve the application of successive layers or volumes of a build material, such as a powder or powder-like build material, to an existing surface (or previous layer). 3D printing may include solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a diagram of an example apparatus that may determine a property of a thermal support based on a color of a portion of a 3D object to be fabricated;

FIG. 2 shows a diagram of an example 3D fabrication system that may form a thermal support to have the determined property and to fabricate the 3D object;

FIG. 3 shows a diagram of another example 3D fabrication system that may form a thermal support near a portion of a 3D object to increase a temperature of the particles used to form the portion; and

FIG. 4 shows a flow diagram of an example method for forming a preheat patch (equivalently recited herein as a thermal support) for a portion of a 3D object to increase a temperature of particles during formation of the portion.

### DETAILED DESCRIPTION

Some types of three-dimensional (3D) fabrication systems may selectively apply a coloring agent, e.g., a printing liquid, ink, etc., of a certain color to build material particles (also referenced herein as “particles”) in layers of particles during fabrication of a 3D object such that the 3D object has the certain color. In some of these types of 3D fabrication systems, a fusing agent may also be applied onto the particles that are to be fused together, e.g., the particles located in areas of multiple layers of particles that are to be fused together to form sections of the 3D object. The fusing agent may enhance absorption of fusing energy emitted from a fusing energy source such that the particles upon which the fusing agent is applied reach their melting point temperature, e.g., at least partially melts, sinters, fuses, or otherwise coalesces. In addition, the fusing energy may be applied at a sufficiently low intensity to prevent the particles upon which the fusing agent has not been applied from reaching their melting point temperature. The coloring agent and the fusing agent may be delivered concurrently or the fusing agent may be applied separately from the coloring agent. In addition, multiple coloring agents and/or multiple fusing agents may be delivered.

As particles upon which the fusing agent has been delivered are heated through application of fusing energy on the particles, heat from those particles may be conducted, e.g., through thermal bleed, to adjacent particles upon which the fusing agent has not been delivered. As a result, some of the adjacent particles may become heated to a temperature above a melting temperature of the particles and may thus at least partially melt. As the melted adjacent particles cool and solidify, the adjacent particles may become fused with the particles upon which the fusing agent has been deposited. As a result, the exact boundary at which the outer surface of a 3D object ends and unfused particles begin may not accurately be controlled in some of these types of fabrication systems. In instances in which the build material particles have a different color than the outer surface of the 3D object, the fusing of the particles outside of the boundary with the particles forming the outer surface may cause the outer surface to have sections of an unintended color.

To compensate for being unable to fabricate the exact boundary, some 3D fabrication systems may apply coloring agent having the same color as the outer surface of the 3D object onto the particles in a tolerance area surrounding the outer surface. This may involve applying coloring agents of different colors that match the colors of the outer surface onto the particles in the tolerance are. The tolerance area may be defined as an area outside of and adjacent to the outer surface of the 3D object that may include particles that may become fused with the particles forming the outer surface of the 3D object. That is, some of the particles in the tolerance area may become fused with some of the melted particles in outer surface of the 3D object and/or may at least partially melt due to thermal bleed that may occur during heating of the particles forming the 3D object. As the particles in the tolerance area may have the same color as the outer surface of the 3D object, when some of the particles in the tolerance area fuse with the particles forming the outer surface of the 3D object, the color of the outer surface may become duller or may not have the intended color. In some examples, the tolerance area for a 3D fabrication system may be determined, for instance, through testing of 3D objects fabricated by the 3D fabrication system and may thus vary among different 3D fabrication systems.

As the particles in the tolerance area may not be intended to form part of the 3D object, fusing agent may not be applied to those particles or a reduced amount of fusing agent may be applied to those particles. A result of the application of the coloring agent to the particles in the tolerance area may be that the coloring agent may cool the particles adjacent to the particles in the tolerance area, including the particles that are to be fused together to form the outer surface of the 3D object. The cooling may result in the temperatures of the particles that are to be fused together to form the outer surface being reduced to a level that may prevent those particles from reaching their melting point temperature. As a result, the particles upon which fusing agent has been deposited to form the outer surface of the 3D object may not sufficiently melt when fusing energy is applied onto those particles.

In instances in which the particles forming part of the 3D object are inadequately and/or improperly fused together, for instance, because the particles did not sufficiently melt, defects may result in the 3D object. For instance, the 3D object may be prevented from having an intended strength, rigidity, hardness, color, translucency, surface roughness, combinations thereof, or the like. However, omission of the application of coloring agent onto the particles in the tolerance area may not be desirable as that may result in defects in the color of the outer surface of the 3D object.

The amount of cooling caused by the coloring agent applied on the particles in the tolerance area on the particles forming the outer surface of the 3D object may differ for different colors. For instance, when the particles are white and the coloring agent is white or nearly white, a relatively small amount of coloring agent may be deposited to color the particles in the tolerance area, which may result in a lesser amount of cooling. In contrast, when the particles are white powder and the coloring agent is red, a relatively large amount of coloring agent may be deposited in the tolerance area, which may result in a greater amount cooling of the particles forming the outer surface of the 3D object.

Disclosed herein are apparatuses and methods for reducing or preventing adverse cooling effects that a coloring agent applied in a tolerance area may have on particles to be formed into part of a 3D object. Particularly, a thermal support (also equivalently referenced herein as a preheat patch) may be fabricated prior to the fabrication of a portion of an outer surface of the 3D object, in which the thermal support may increase the temperature of the particles in the tolerance area. According to examples, the thermal support may be fabricated to increase the temperature of the particles in the tolerance area to a certain temperature level such that those particles are above a certain temperature after the coloring agent has been applied onto those particles. The certain temperature level may be a temperature that enables the particles to be formed into the portion of the outer surface of the 3D object to reach their melting point temperature after fusing agent is deposited and fusing energy is applied onto those particles. The certain temperature level may also be a temperature that prevents the particles in the tolerance area from reaching their melting point temperature when fusing energy is applied to the particles upon which fusing agent has been deposited.

The thermal support may be formed as an area in a powder bed outside of and distinct from the outer surface of the 3D object. The thermal support may be fused together through application of a fusing agent and fusing energy such that thermal bleed from the thermal support may increase the temperature of the particles around the thermal support. Thus, for instance, the thermal support may increase the temperature of the particles in the tolerance area, which may result in a decrease of the amount of cooling caused by the particles in the tolerance area onto particles to be formed into part of the 3D object as may result from the application of coloring agent onto the particles in the tolerance area.

The apparatuses and methods disclosed herein may determine a property of the thermal support that is to be fabricated near a portion of a 3D object. According to examples, the property of the thermal support may be determined to raise the temperature of the particles around the thermal support, e.g., the particles in the tolerance area, by a predetermined amount, e.g., by between about 5° C. and about 10° C., such that the amount of cooling of the particles used to form the 3D object caused by the particles in the tolerance area may be reduced. The property, which may be a size, a position, a composition, a shape, and/or the like, of the thermal support may be based on an identified color of the portion of the 3D object. That is, for instance, the property of the thermal support may be determined based on an amount of cooling predicted to be caused by the coloring agent on the particles in the tolerance area on the particles to be formed into part of the 3D object. The property of the thermal support may also be determined such that the thermal support does not increase the temperature of the particles around the thermal support beyond a specified amount as that may result in excessive melting of the particles in the tolerance area and/or the particles within the boundary of the 3D object.

Through implementation of the apparatuses and methods disclosed herein, 3D objects may be fabricated to have substantially increased mechanical strength, more accurate colors, improved surface quality, and/or the like.

Before continuing, it is noted that as used herein, the terms “includes” and “including” mean, but is not limited to, “includes” or “including” and “includes at least” or “including at least.” The term “based on” means “based on” and “based at least in part on.” In addition, references herein to melted particles may also be defined as including at least partially melted particles.

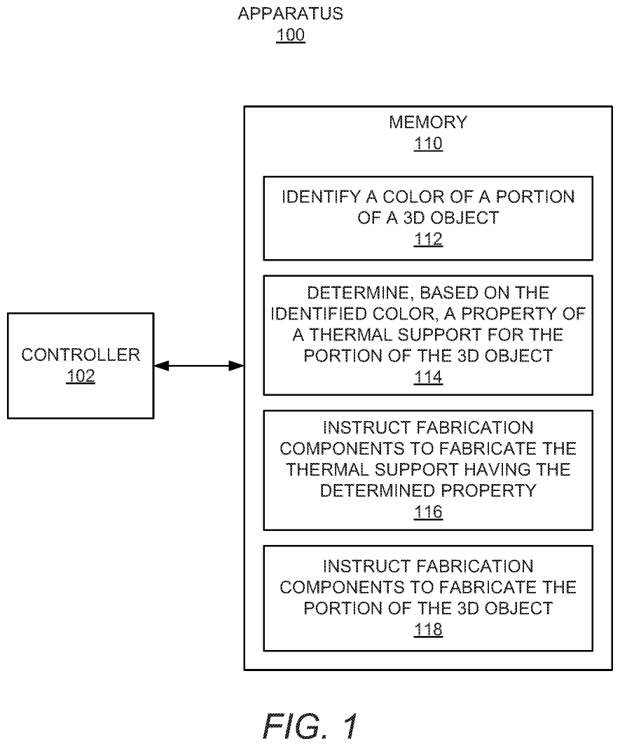

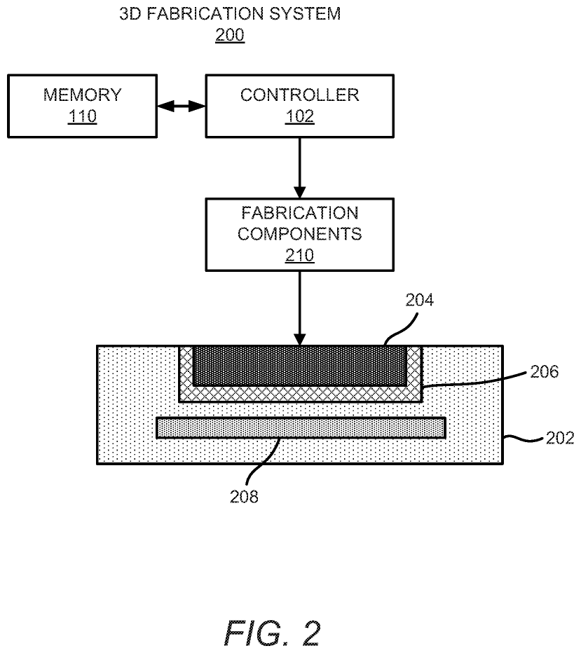

Reference is first made to FIGS. 1 and 2. FIG. 1 shows a diagram of an example apparatus 100 that may determine a property of a thermal support based on a color of a portion of a 3D object to be fabricated. FIG. 2 shows a diagram of an example 3D fabrication system 200 that may control fabrication components to fabricate the thermal support to have the determined property and to fabricate the 3D object. It should be understood that the apparatus 100 depicted in FIG. 1 and the 3D fabrication system 200 depicted in FIG. 2 may include additional components and that some of the components described herein may be removed and/or modified without departing from the scopes of the apparatus 100 and the 3D fabrication system 200 disclosed herein.

Generally speaking, the apparatus 100 may be a computing device, a control device of the 3D fabrication system 200, or the like. In some examples, the apparatus 100 may be separate from the 3D fabrication system 200 while in other examples, the apparatus 100 may be incorporated with the 3D fabrication system 200. The 3D fabrication system 200 may also be termed a 3D printer, a 3D fabricator, or the like, and may be implemented to fabricate 3D objects from particles 202 of build material, which may also be termed build material particles 202. That is, the 3D fabrication system 200 may fabricate 3D objects through selective fusing of the particles 202.

The apparatus 100 may include a controller 102 that may control operations of the apparatus 100 and, in some examples, the 3D fabrication system 200. The controller 102 may be a semiconductor-based microprocessor, a central processing unit (CPU), an application specific integrated circuit (ASIC), a field-programmable gate array (FPGA), and/or other suitable hardware device.

The apparatus 100 may also include a memory 110 that may have stored thereon machine readable instructions 112-118 (which may also be termed computer readable instructions) that the controller 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals.

The controller 102 may fetch, decode, and execute the instructions 112 to identify a color of a portion of a 3D object, in which a 3D object is to be fabricated based on a 3D model of the 3D object. That is, the controller 102 may access a data file, e.g., a CAD file, or other file, corresponding to the 3D model and may identify the color of the portion of the 3D object from the data file. The portion of the 3D object may be a section of an outer surface of the 3D object identified by the 3D model. By way of example, the portion of the 3D object may be a portion of the outer surface at a bottom of the 3D object identified by the 3D model. A portion 204 of a 3D object is depicted in FIG. 2 as being formed from particles 202 of build material.

The particles 202 of build material may include any suitable material including, but not limited to, a polymer, a plastic, a ceramic, a nylon, a metal, combinations thereof, or the like, and may be in the form of a powder or a powder-like material. Additionally, the particles 202 may be formed to have dimensions, e.g., widths, diameters, or the like, that are generally between about 5 μm and about 100 μm. In other examples, the particles 202 may have dimensions that are generally between about 30 μm and about 60 μm. The particles 202 may have any of multiple shapes, for instance, as a result of larger particles being ground into smaller particles. In some examples, the powder may be formed from, or may include, short fibers that may, for example, have been cut into short lengths from long strands or threads of material. According to an example, a suitable build material may be PA12 build material commercially known as V1R10A “HP PA12” available from HP Inc.

As discussed herein, a coloring agent having the same or similar color as the color of the portion 204 may be applied to the particles 202 located in a tolerance area 206 adjacent to the portion 204 of the 3D object. Thus, the selection of the coloring agent applied to the particles 202 in the tolerance area 206 may be based on the color of the portion 204. As also discussed herein, the color of the coloring agent may affect the amount that the particles 202 in the tolerance area 206 are cooled, which may also affect the amount that the particles 202 used to form the portion 204 of the 3D object are cooled. According to examples, the controller 102 may identify that a thermal support 208 may be fabricated to compensate for the cooling caused by the application of the coloring agent on the particles 202 in the tolerance area 206 on the particles 202 to be formed into the portion 204.

That is, the controller 102 may fetch, decode, and execute the instructions 114 to determine, based on the identified color of the portion 204 of the 3D model, a property of a thermal support 208 for the portion 204 of the 3D object, in which the property of the thermal support 208 may affect a temperature of an area near the particles 202 used to form the portion 204 of the 3D object. For instance, the thermal support 208 may affect the temperature, e.g., increase the temperature, of the particles 202 in the tolerance area 206, which may, in turn, affect the temperature of the particles 202 used to form the portion 204 of the 3D object, e.g., reduce cooling of the particles 202 used to form the portion 204. In addition, the property of the thermal support 208, which may include a size, a position, a composition, a shape, and/or the like, may affect the amount of temperature increase applied to the particles 202 in the tolerance area 206. For instance, a larger thermal support 208 may result in a larger increase in temperature of the particles 202 in the tolerance area 206 while a smaller thermal support 208 may result in a smaller temperature increase. Likewise, a closer thermal support 208 may result in a larger temperature increase.

According to examples, the controller 102 may determine an amount of cooling predicted to occur in the particles 202 used to form the portion 204 based on the identified color of the portion 204 and thus, the color of the coloring agent to be applied in the tolerance area 206. The controller 102 may make this determination based on the type of material of the particles 202, the type of coloring agent to be applied, the type of fusing element to be implemented, etc. In some examples, the amount of cooling for various combinations of particle types, coloring agent types, fusing elements, etc., may have been previously determined through empirical testing and/or modeling and various correlations between the cooling and the various combinations may be stored in a database, e.g., in a look-up table. In these examples, the controller 102 may determine the predicted amount of cooling from the look-up table.

The controller 102 may determine the property of the thermal support 208 based on the determined amount of cooling predicted to occur. That is, the controller 102 may determine the amount of heating, e.g., through thermal bleed, caused by the thermal support 208 that is to be supplied to the particles 202 used to form the portion 204 to compensate for the determined amount of cooling predicted to occur. The controller 102 may determine that the thermal support 208 is to have a particular size, a particular shape, a particular composition, be formed at a particular distance from the tolerance area 206, and/or combinations thereof, etc., to compensate for the determined amount of cooling predicted to occur.

In addition, the controller 102 may determine the property of the thermal support 208 such that the thermal support 208 may increase the temperature of the particles used to form the portion 204 without exceeding a predefined temperature. That is, the controller 102 may determine the property such that the thermal support 208 may not cause the temperature of the particles 202 used to form the portion 204 to exceed the predefined temperature when fusing energy is applied onto the particles 202 by a fusing element. The predefined temperature may be defined as a temperature at which the particles 202 may exceed a temperature limit during application of the fusing energy on the particles 202.

The controller 102 may determine the property of the thermal support 208 based on the color of the portion 204 and thus, the color of the coloring agent to be applied to the tolerance area 206 adjacent to the portion 204. In some examples, the properties of the thermal support 208 for various colors may have been previously determined through empirical testing and/or modeling and various correlations between the cooling and the various combinations may be stored in a database, e.g., in a look-up table. In addition to the colors, the properties may also be determined for various types coloring agents, various types of particles, etc. In any regard, the controller 102 may determine the property of the thermal support 208 from the database.

In some examples, the controller 102 may determine that a thermal support 208 may not be fabricated. For instance, the controller 102 may determine that a thermal support 208 may not be fabricated in instances in which the color of the portion 204 is not likely to result in the temperature of the particles 202 used to form the portion 204 being reduced to an unacceptable level. By way of particular example, the controller 102 may determine that a thermal support 208 may not be fabricated in an instance in which the color of the portion 204 is white and the particles 202 are white and thus a relatively small amount of coloring agent may be applied to the particles 202 in the tolerance area 206.

In addition, or alternatively, in instances in which the outer surface of the 3D object includes portions 204 of multiple colors, the controller 102 may determine that multiple thermal supports 208 may be fabricated. In these instances, the controller 102 may determine a respective property for each of the multiple thermal supports 208 based on the multiple colors. The controller 102 may also determine the respective locations at which the multiple thermal supports 208 are to be fabricated within a build chamber, e.g., within layers of particles 202, to affect the temperatures of the particles to be formed into the portions 204. Moreover, the controller 102 may determine the thermal support or supports 208 to have shapes that follow and/or correspond to the shape(s) of the portion(s) 204.

The controller 102 may fetch, decode, and execute the instructions 116 to instruct fabrication components 210 to fabricate the thermal support 208 having the determined property. Particularly, the controller 102 may instruct (or control) the fabrication components 210 to fabricate the thermal support 208 in layers of particles 202 located with respect to a portion 204 of the 3D object. As shown in FIG. 2, the fabrication components 210 may fabricate the thermal support 208 beneath and at a location that is spaced from the portion 204. In any regard, the thermal support 208 may increase the temperature of a set of particles used to fabricate the portion of the 3D object. That is, the thermal support 208 may be fabricated in particles 202 of earlier applied layers and the portion 204 may be fabricated in particles 202 of later applied layers as discussed in greater detail herein. As the thermal support 208 may be fabricated in earlier applied layers, heat from the thermal support 208 may conduct or bleed into the later applied layers of particles 202, which may increase the temperature of the particles 202 in the tolerance area 206.

Following the fabrication of the thermal support 208, the controller 102 may control the fabrication components 210 to apply a coloring agent onto particles 202 located in the tolerance area 206. As the particles 202 in the tolerance area 206 may not be intended to be fused together or fused to particles forming the portion 204, the controller 102 may not control the fabrication components 210 to apply a fusing agent onto the particles 202 located in the tolerance area 206.

The controller 102 may fetch, decode, and execute the instructions 118 to instruct (or control) the fabrication components 210 to fabricate the portion 204 during and/or after application of the coloring agent onto the particles 202 located in the tolerance area 206. As discussed herein, the thermal support 208 may compensate for the cooling applied to the particles 202 to be formed into the portion 204 caused by the coloring agent applied to the particles 202 in the tolerance area 206. That is, the thermal support 208 may increase the temperature of the particles 202 in the tolerance area 206 such that the amount of cooling caused by those particles may be reduced. In one regard, the reduction in cooling effect may enable the particles 202 to be formed into the portion 204 to reach their melting point temperature.

In other examples, instead of the memory 110, the apparatus 100 may include hardware logic blocks that may perform functions similar to the instructions 112-118. In yet other examples, the apparatus 100 may include a combination of instructions and hardware logic blocks to implement or execute functions corresponding to the instructions 112-118. In any of these examples, the controller 102 may implement the hardware logic blocks and/or execute the instructions 112-118.

It should be noted that the orientation of the portion 204 depicted in FIG. 2 is for purposes of illustration and not of limitation. As such, for instance, although the thermal support 208 is depicted as being positioned below the portion 204, in instances in which the portion 204 is rotated at an angle, the thermal support 208 may also be rotated, e.g., may have the same orientation with respect to the portion 204. In these instances, sections of the thermal support 208 and the portion 204 may be formed in some of the same layers of the particles 202.

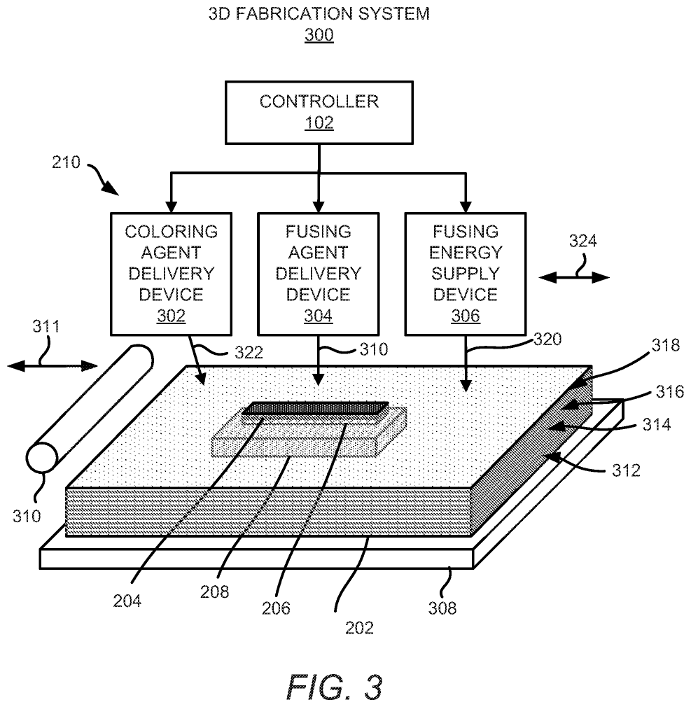

Turning now to FIG. 3, there is shown a diagram of another example 3D fabrication system 300 that may form a thermal support 208 near a portion 204 of a 3D object to increase a temperature of the particles 202 used to form the portion 204. The 3D fabrication system 300 may be similar to the 3D fabrication system 200 depicted in FIG. 2 and may include many of the same components. In the 3D fabrication system 300, however, the fabrication components 210 are depicted as including a coloring agent delivery device 302, a fusing agent delivery device 304, a fusing energy supply device 306, a build platform 308, and a spreader 310. The fabrication components 210 may be included in a build chamber within which 3D objects may be fabricated from the particles 202 provided in respective layers on the build platform 308.

According to examples, the controller 102 may control the spreader 310 to apply layers 312-318 of particles 202 on the build platform 308 and the build platform 308 may be moved downward as the layers 312-318 of particles 202 are applied over the build platform 308. The particles 202 may be supplied between the spreader 310 and the build platform 308 and the spreader 310 may be moved in either or both directions represented by the arrow 311 across the build platform 308 to spread the particles 202 into a layer. The layers 312-318 of the particles 202 have been shown as being partially transparent to enable the portion 204, the tolerance area 206, and the thermal support 208 to be visible. It should, however, be understood that the particles 202 may not be transparent, but instead, may be opaque.

In a first set of the layers 312, the controller 102 may control the fusing agent delivery device 304 to selectively apply fusing agent 310 to fabricate the thermal support 208. According to examples, the controller 102 may control the fusing agent delivery device 304 to selectively apply the fusing agent 310 and may control the fusing energy supply device 306 to apply fusing energy 320 to fabricate the thermal support 208 to have the determined property. That is, the controller 102 may control the fusing agent delivery device 304 and the fusing energy supply device 306 to fabricate the thermal support 208 to have a particular size, shape, composition, etc. The composition of the thermal support 208 may include a volume of the fusing agent 310 applied to the particles in the first set of layers 312 and/or a mixture of the fusing agent 310 with another material. The other material may be another liquid, metallic particles, or the like, which may differ from the fusing agent 310.

Following the fabrication of the thermal support 208, the controller 102 may create an intermediate (or second) set of the layers 314 in dry form, e.g., the controller 102 may not instruct the coloring agent delivery device 302 to deliver coloring agent 320 or the fusing agent delivery device 302 to delivery fusing agent 310 to the particles 202 in the intermediate set of the layers 314.

On a third set of layers 316 located above the intermediate set of layers 314, the controller 102 may control the coloring agent delivery device 302 to selectively deliver coloring agent 322. The third set of layers 316 may be or may form part of the tolerance area 206 around portion 204 of the 3D object. As discussed herein, coloring agent having the same color as the portion 204 may be delivered to the particles 202 in the tolerance area 206 because some of those particles 202 may become fused with particles 202 forming the portion 204.

On a fourth set of layers 318, the controller 102 may control the coloring agent delivery device 302 to selectively deliver coloring agent 322 to areas of particles 202 that are in the tolerance area 206 and that are to form the portion 204. The controller 102 may also control the fusing agent delivery device 304 to selectively deliver fusing agent 310 to the particles 202 in areas that are to form the portion 204. The controller 102 may further control the fusing energy supply device 306 to supply fusing energy onto the fourth set of layers 318 to increase the temperature of the particles 202 on which the fusing agent 310 has been delivered above the melting point temperature of the particles 202. The particles 202 on which the fusing agent 310 has been delivered may thus fuse together during cooling and solidification of the particles 202 to form the portion 204 as a solid component of the 3D object. Following the formation of the portion 204, additional sections of the 3D object may be fabricated on additional layers until fabrication of the 3D object is completed.

As shown in FIGS. 2 and 3, the thermal support 208 may be formed from particles 202 located beneath and in relatively close proximity to the particles 202 in the tolerance area 206 and forming the portion 104, in which the thermal support 208 does not form part of the 3D object and is not in contact with the portion 204. In addition, the portion 204 and the tolerance are 206 may be separated from the thermal support 208 by an intermediate set of layers 314, which may be at least one layer of unfused particles 202. The intermediate section may have a sufficient height to keep particles 202 in the tolerance area 206 from fusing with particles 202 forming the thermal support 208. By way of particular example, the intermediate section may include between about 10 layers and about 20 layers of unfused particles 202.

According to examples, the same fusing agent 310 may be used to form both the thermal support 208 and the portion 204. In some examples, the fusing agent delivery device 304 may be operated to deposit droplets of the fusing agent 310 at different concentration levels, e.g., contone levels, to form the thermal support 208 and the portion 204. That is, for instance, the controller 102 may control the fusing agent delivery device 304 to deposit droplets of the fusing agent 310 at a higher contone level to form the portion 204 than to form the thermal support 208. In other examples, the controller 102 may control the fusing agent delivery device 304 to deposit droplets of the fusing agent 310 at a lower contone level to form the portion 204 than to form the thermal support 208.

In some examples, the coloring agent delivery device 302, the fusing agent delivery device 304, and the fusing energy supply device 306 may be supported on a carriage (not shown) that is to move in the directions denoted by the arrow 324. In some examples, the spreader 310 may be provided on the same carriage. In other examples, the coloring agent delivery device 302, the fusing agent delivery device 304, and the fusing energy supply device 306 may be supported on a plurality of carriages such that the coloring agent delivery device 302, the fusing agent delivery device 304, and/or the fusing energy supply device 306 may be moved separately with respect to each other.

Although not shown, the 3D fabrication system 300 may include a heater to maintain an ambient temperature of the build envelope or chamber at a relatively high temperature. In addition or in other examples, the build platform 308 may be heated to heat the particles 202 to a relatively high temperature. The relatively high temperature may be a temperature near the melting temperature of the particles 202 such that a relatively low level of fusing energy 314 may be applied to selectively fuse the particles 302.

The coloring agent 322 may be a liquid, such as an ink, a pigment, a dye, or the like, that the particles 202 may absorb such that the particles 202 may become the same or similar color as the coloring agent. The coloring agent delivery device 302 may deliver the coloring agent 322 in the form of droplets. Although the 3D fabrication system 300 has been depicted as including a single coloring agent delivery device 302, the 3D fabrication system 300 may include additional coloring agent delivery devices to, for instance, deliver coloring agents of different colors onto the particles 202. In this regard, references to the coloring agent delivery device 302 herein may also be construed as pertaining to multiple coloring agent delivery devices 302.

The fusing agent 310 may be a liquid, such as an ink, a pigment, a dye, or the like, that may enhance absorption of fusing energy 320 emitted from the fusing energy supply device 306. The fusing agent delivery device 304 may deliver the fusing agent 310 in the form of droplets onto the layer of particles 202 such that the droplets of fusing agent 310 may be dispersed on the particles 202 and within interstitial spaces between the particles 202 forming the portion 204 and in some examples, the thermal support 208. In forming the portion 204, the droplets of fusing agent 310 may be supplied at a sufficient density, e.g., contone level, to enhance absorption of sufficient energy 320 to cause the temperature of the particles 202 on which the fusing agent 310 has been deposited to increase to a level that is above a melting point temperature of the particles 202. In addition, the fusing energy supply device 306 may supply energy 320 at a level that is insufficient to cause the particles 202 upon which the fusing agent 310 has not been supplied to remain below the melting point temperature of the particles 202.

According to an example, a suitable fusing agent may be an ink-type formulation including carbon black, such as, for example, the fusing agent formulation commercially known as V1Q60Q “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc.

The fusing energy supply device 306 may include a single energy supply device or multiple energy supply devices. In any regard, the fusing energy supply device 306 may supply any of various types of energy. For instance, the fusing energy supply device 306 may supply energy in the form of light (visible, infrared, or both), in the form of heat, in the form of electromagnetic energy, combinations thereof, or the like. According to examples, the type and/or amount of fusing agent 310 and in some examples, the type and/or amount of coloring agent 322 deposited onto the particles 202, may be tuned to the type and strength of the fusing energy 320 that the fusing energy supply device 306 emits such that, for instance, the particles 202 may be heated as intended. By way of example, the tuning may be implemented to maximize the heating of the particles 202 while minimizing the amount of fusing energy 320 applied by the fusing energy supply device 306.

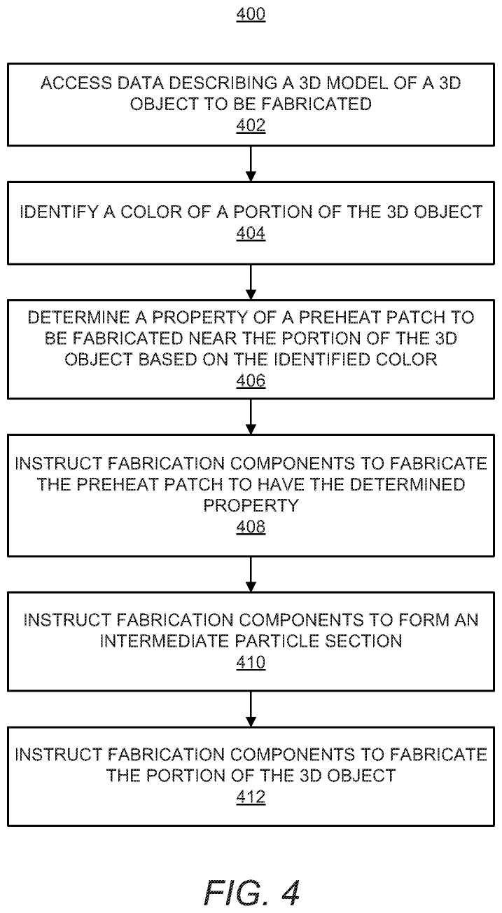

Various manners in which the controller 102 may operate are discussed in greater detail with respect to the method 400 depicted in FIG. 4. Particularly, FIG. 4 depicts a flow diagram of an example method 400 for forming a preheat patch 208 (equivalently recited herein as a thermal support 208) for a portion 204 of a 3D object to increase a temperature of particles 202 during formation of the portion 204. It should be understood that the method 400 depicted in FIG. 4 may include additional operations and that some of the operations described therein may be removed and/or modified without departing from a scope of the method 400. The description of the method 400 is made with reference to the features depicted in FIGS. 1-3 for purposes of illustration.

At block 402, a processor, e.g., the controller 102, may access data, e.g., a data file, describing a 3D model of a 3D object to be fabricated. At block 404, the processor may identify, from the accessed file, a color of a portion 204 of the 3D object. Particularly, for instance, the processor may identify a color of a portion 204 of an outer surface of the 3D object.

At block 406, the processor may determine, based on the identified color, a property of a preheat patch 208 to be fabricated near the portion of the 3D object, the property affecting a temperature of the particles 202 near the particles 202 used to fabricate the portion 204 of the 3D object, e.g., the particles 202 in the tolerance area 206. As discussed herein, a tolerance area around the 3D object may include particles 202 located adjacent to the portion 204 that are to receive a coloring agent 322 to cause the 202 particles in the tolerance area 206 to have the identified color, in which the particles 202 in the tolerance area 206 are not to fuse to each other. In some examples, the processor may determine the amount of cooling caused by the coloring agent deposited on the particles in the tolerance area, which may be based on the color of the coloring agent. In addition, the processor may determine the property of the preheat patch 208 to apply a sufficient thermal bleed rate, e.g., the rate at which heat from the preheat patch 208 bleeds to the particles 202 to be formed into the portion 204, to compensate for the determined amount of cooling caused by the coloring agent deposited on the particles 202 in the tolerance area 206.

As discussed herein, various correlations between the cooling caused by different colored coloring agents and preheat patch 208 properties may be determined through testing and/or modeling and the various combinations may be stored in a database, e.g., in a look-up table. In these examples, the processor may access the look-up table and may determine the property of the preheat patch 208 for the portion 204 of the 3D object based on the identified color of the portion 204 from the look-up table.

At block 408, the processor may instruct the fabrication components 210 to fabricate the preheat patch 208 to have the determined property in a first set of particles 202. For instance, the processor may instruct the fabrication components 210 to fabricate the preheat patch 208 in a first set of layers 312. The processor may control the spreader 310 to spread the first set of particle layers 312 and may control the fusing agent delivery device 304 to selectively deliver fusing agent 310 onto the particle layers 312 as discussed herein.

At block 410, the processor may instruct the fabrication components to form an intermediate particle section 314/316 on the first set of particles 202. As discussed above, the processor may control the spreader 310 to apply a second set of particle layers 314, in which the particles 202 in the second set of particle layers 314 may remain unfused. In addition, the processor may control the spreader 310 to apply a third set of particle layers 316 and the coloring agent delivery device 302 to deliver coloring agent to the particles 202 in the third set of particle layers 316.

At block 412, the processor may instruct the fabrication components to fabricate the portion 204 of the 3D object in a fourth set of particles 202 on the intermediate particle section 314/316. The processor may control the spreader 310 to apply a fourth set of particle layers 318 and the processor may control the coloring agent delivery device 302 to selectively deliver coloring agent 322, and the fusing agent delivery device 304 to selectively deliver fusing agent 310 onto the apply fourth set of particle layers 318 at locations to be formed into the portion 204. In addition, the processor may control the coloring agent delivery device 302 to selectively deliver coloring agent on the particles 202 in the fourth set of particle layers 318 located in the tolerance area 206. In some examples, sections of the preheat patch 208, the intermediate particle section 314/316, and the portion 204, may be formed on the same set of particle layers, for instance, when the portion 204 is at an angle or includes an angled section.

According to examples, the 3D object to be fabricated may include an outer surface having multiple portions 204, in which each of the multiple portions 204 is to have one of multiple colors. In these examples, the processor may determine respective properties for a plurality of preheat patches 208 to be fabricated for the portions 204 based on the respective colors of the portions 204. In addition, the processor may instruct the fabrication components 210 to fabricate the plurality of preheat patches 204 to have the respective properties at locations with respect to the portions 204 having colors to which the plurality of preheat patches 204 were respectively determined.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor;
a memory on which is stored machine readable instructions that when executed by the processor, cause the processor to:
identify a color of a portion of a three-dimensional (3D) object to be fabricated from a 3D model of the 3D object;
determine, based on the identified color of the portion of the 3D object, a property of a thermal support for the portion of the 3D object, wherein the property affects a temperature of an area near build material particles used to form the portion of the 3D object;
instruct fabrication components to fabricate the thermal support having the determined property; and
instruct the fabrication components to fabricate the 3D object, the thermal support being fabricated at a location with respect to the portion of the 3D object to increase a temperature of a set of particles used to fabricate the portion of the 3D object during fabrication of the portion of the 3D object.

2. The apparatus of claim 1, wherein the property includes a size, a placement, a composition, or a combination thereof of the thermal support.

3. The apparatus of claim 1, wherein the property of the thermal support corresponds to a thermal bleed rate of the thermal support, and wherein the instructions are further to cause the processor to:
determine an amount of cooling caused by a coloring agent applied on the set of particles to fabricate the portion of the 3D object with the identified color; and
determine the property of the thermal support to apply a sufficient thermal bleed rate to compensate for the determined amount of cooling caused by the applied coloring agent.

4. The apparatus of claim 1, wherein the portion of the 3D object is part of an outer surface of the 3D object, wherein a tolerance area around the 3D object includes particles located adjacent to the portion that are to receive a coloring agent to cause the particles in the tolerance area to have the identified color, wherein the particles in the tolerance area are not to fuse to each other, and wherein the instructions are further to cause the processor to:
determine the amount of cooling caused by the coloring agent deposited on the particles in the tolerance area; and
determine the property of the thermal support to apply a sufficient thermal bleed rate to compensate for the determined amount of cooling caused by the coloring agent deposited on the particles in the tolerance area.

5. The apparatus of claim 1, wherein the instructions are further to cause the processor to:
access a look-up table including correlations between colors of the portion of the 3D object and properties of the thermal support; and
determine the property of the thermal support for the portion of the 3D object based on the identified color of the portion from the look-up table.

6. The apparatus of claim 1, wherein the fabrication components are to selectively deposit a fusing agent to fabricate the thermal support according to the determined property and wherein the instructions are further to cause the processor to:
determine the property of the thermal support to be an amount of fusing agent to be deposited onto particles to fabricate the thermal support, wherein a larger amount of fusing agent causes the thermal support to dissipate a greater amount of heat during application of fusing energy onto the fusing agent.

7. The apparatus of claim 1, wherein the 3D object is to be fabricated to include an outer surface having multiple portions, each of the multiple portions to have one of multiple colors, and wherein the instructions are to cause the processor to:
determine respective properties for a plurality of thermal supports to be fabricated for the portions based on the respective colors of the portions; and
instruct the fabrication components to fabricate the plurality of thermal supports to have the respective properties at locations with respect to the portions having colors to which the plurality of thermal supports were respectively determined.

8. The apparatus of claim 1, wherein the instructions are further to cause the processor to:
instruct the fabrication components to form a first set of particle layers;
instruct the fabrication components to selectively deposit a fusing agent onto the first set of particle layers according to the determined property of the thermal support;
instruct the fabrication components to apply fusing energy onto the first set of particle layers to fabricate the thermal support having the determined property;
instruct the fabrication components to form a second set of particle layers on the first set of particle layers;
instruct the fabrication components to form a third set of particle layers on the second set of particle layers;
instruct the fabrication components to selectively deposit a coloring agent and a fusing agent onto the third set of particle layers according to the portion of the 3D object as defined in the 3D model; and
instruct the fabrication components to apply fusing energy onto the third set of particle layers to fabricate the portion of the 3D object.

9. A method comprising:
accessing, by a processor, data describing a three-dimensional (3D) model of a 3D object to be fabricated;
identifying, by the processor, a color of a portion of the 3D object;
determining, by the processor and based on the identified color, a property of a preheat patch to be fabricated near the portion of the 3D object, the property affecting a temperature of particles near particles used to fabricate the portion of the 3D object;
instructing, by the processor, fabrication components to fabricate the preheat patch to have the determined property in a first set of particles;
instructing, by the processor, fabrication components to form an intermediate particle section on the first set of particles; and
instructing, by the processor, the fabrication components to fabricate the portion of the 3D object in a second set of particles on the intermediate particle section.

10. The method of claim 9, wherein the portion of the 3D object is part of an outer surface of the 3D object, wherein a tolerance area around the 3D object includes particles located adjacent to the portion that are to receive a coloring agent to cause the particles in the tolerance area to have the identified color, wherein the particles in the tolerance area are not to fuse to each other, the method further comprising:
determining the amount of cooling caused by the coloring agent deposited on the particles in the tolerance area; and
determining the property of the preheat patch to apply a sufficient thermal bleed rate to compensate for the determined amount of cooling caused by the coloring agent deposited on the particles in the tolerance area.

11. The method of claim 9, further comprising:
accessing a look-up table including correlations between colors of the portion of the 3D object and properties of the preheat patch; and
determining the property of the preheat patch for the portion of the 3D object based on the identified color of the portion from the look-up table.

12. The method of claim 9, wherein the 3D object is to be fabricated to include an outer surface having multiple portions, each of the multiple portions to have one of multiple colors, the method further comprising:
determining respective properties for a plurality of preheat patches to be fabricated for the portions based on the respective colors of the portions; and
instructing the fabrication components to fabricate the plurality of preheat patches to have the respective properties at locations with respect to the portions having colors to which the plurality of preheat patches were respectively determined.

13. The method of claim 9, wherein determining the property of the preheat patch further comprises determining a size, a fusing agent amount, or a placement of the preheat patch, or a combination thereof based on the identified color of the portion of the 3D object.

14. A non-transitory computer readable medium on which is stored machine readable instructions that when executed by a processor, cause the processor to:
access a three-dimensional (3D) model of a 3D object to be fabricated, the 3D model identifying a portion of an outer surface of the 3D object;
identify a color of the portion of the outer surface;
determine a property of a preheat patch to be fabricated adjacent to and spaced from the portion of the outer surface, the property affecting a temperature of an area near particles used to fabricate the portion of the outer surface;
output instructions to cause:
the preheat patch to be fabricated with the determined property; and
the portion of the outer surface to be fabricated sufficiently close to the preheat patch to cause heat from the preheat patch to raise a temperature of some of the particles in the area near particles used to fabricate the portion of the outer surface during fabrication of the portion of the outer surface.

15. The non-transitory computer readable medium of claim 14, wherein a tolerance area is to be formed around the outer surface, the tolerance area including particles located adjacent to the portion of the outer surface that are to receive a coloring agent to cause the particles in the tolerance area to have the identified color without the particles in the tolerance area fusing to each other, and wherein the instructions are further to cause the processor to:
determine the amount of cooling caused by the coloring agent deposited on the particles in the tolerance area; and
determine the property of the preheat patch to compensate for cooling of particles to be formed into the outer surface caused by deposition of the coloring agent on the particles in the tolerance area.
